(19) United States
(12) Patent Application Publication
(10) Pub. No.: US 2006/0163267 A1
(43) Pub. Date: Jul. 27, 2006

(54) Dial-type pill dispenser with timer and reminder means

(76) Inventor: Joshua Lapsker, Barbados, WI (US)

Correspondence Address: KLAUBER & JACKSON, 411 HACKENSACK AVENUE, HACKENSACK, NJ, 07601, US

(21) Appl. No.: 11/041,007

(22) Filed: Jan. 21, 2005

(51) Int. Cl. G07F 11/00

(52) U.S. Cl. 221/2

(57) ABSTRACT

A dial-type pill dispenser for pills and the like, comprising a tray with individually marked storage compartments, a cover for selectively covering the compartments until accessed, and a central connector hub which rotatably holds together the tray and the cover, and a timer and reminder means. User can access the individual storage compartments by dial to the appropriately marked compartment with a twist of the hand. By rotating the cover and tray relative to each other, an aperture on the cover will coincide with the open faced side of the individual compartment desired, so as to be able to access the particular pill in a marked position. A timer and visual and/or audio reminder means may be set or programmed so as to alert the user regarding the need to access (a) given pill(s).

### BACKGROUND OF THE INVENTION

1. Field of the Invention

This invention relates to a dial-type dispenser for medication such as pills, capsules and tablets. It particularly relates to a multi-compartmented dispenser for storing and selectively dispensing at least one pill at a plurality of intervals during a succession of days or administrations. A timer and reminder means is further included for notifying a user as to when a pill needs to accessed and administered.

2. Description of the Prior Art

Many pill dispensers with compartments for storing and dispensing vitamins, pharmaceutical pills, tablets, and capsules are available. However, such boxes do not provide for a reliable reminder means for alerting or reminding users when they need to take their next dose. In addition, some boxes are inconvenient to use because of their shape and because of the difficulty in opening them. Typically, their effectiveness is often compromised by the lack of a convenient design for the physically impaired user, such as people with poor vision or elderly people with little strength in their hands.

To this end, the pill dispenser devices of the prior art do not provide a versatile, easy to use means for dispensing pills for all types of users, nor do the prior art devices offer the added benefit of a reminder means to ensure the timely administration of pills.

### SUMMARY AND OBJECTS OF THE INVENTION

It is accordingly an object of this invention to provide a pill dispenser having means for storing and dispensing a plurality of pills, such as an entire week supply of pills.

It is also an object to provide a pill dispenser having a means for selecting a daily supply or individual dosage of pills by rotation from a closed (storage) position of the cover and the tray of the device.

It is accordingly a further object of this invention to provide a reminder means on the pill dispenser to remind a user when he needs to take (a)pill(s).

It is further an object to provide a pill dispenser having means for locating a daily supply or individual dosage when the user is visually impaired.

It is additionally an object to provide a pill dispenser having a means for grasping and manipulating that are within the capabilities of persons with arthritis and of elderly people having little strength in their hands and fingers.

In accordance with these objects and the principles of this invention, a dial-type pill dispenser is provided that comprises a wide, shallow, circular container having a centrally situated connector hub for rotably fixing a cover and a tray together, and a plurality of storage compartments within the tray that may be closed or exposed by rotation of the cover by a given user. A reminder means, such as a clock and alarm, is provided for on the dispenser at or within the connector hub.

### BRIEF DESCRIPTIONS OF THE DRAWINGS

The dial-type pill dispenser may be more readily understood by reference to the following drawings in which like reference numbers designate corresponding parts.

FIG. 1A is a top-side view of the container in an open position, exposing one of the marked compartments in which pills may be stored;

FIG. 1B is a bottom-side view of the container in an open position, showing one embodiment of a reminder means with a clock centrally disposed at the hub;

FIG. 2 is an exploded top perspective view of the entire dial-type pill dispenser, while empty, so that the relationship of its components is readily understood.

FIG. 3 is an exploded bottom perspective view of the entire dial-type pill dispenser, while empty, so that the relationship of its components is readily understood.

FIG. 4 is an expanded view of the connector hub portion of the dial-type pill dispenser in one embodiment, so that the relationship of its fit therein is readily understood.

FIG. 5 is an expanded and offset view of the tray portion of the dial-type pill dispenser in one embodiment, so that the relationship of its fit therein is readily understood.

FIG. 6 is an expanded view of the cover portion of the dial-type pill dispenser in one embodiment, so that the relationship of its fit therein is readily understood.

FIG. 7 is an expanded view of an alternative structure of the connector hub portion of the dial-type pill dispenser in one embodiment, so that the relationship of its fit therein is readily understood.

FIG. 8 is an expanded view of an alternative structure of the cover portion of the dial-type pill dispenser in one embodiment, so that the relationship of its fit therein is readily understood.

FIG. 9 is an expanded view of the timer and reminder means part of the connector hub portion of the dial-type pill dispenser in one embodiment, so that the relationship of its fit therein is readily understood.

### DESCRIPTION OF THE PREFERRED EMBODIMENTS

In its broadest aspect, the inventive dial-type pill dispenser with reminder means comprises a toroidal tray formed about a plane, wherein the tray has a central axis substantially perpendicular to the plane, about which a connector hub is situated and about which a cover is rotably fixed relative to the tray. The tray has an inner ring surface, an outer ring surface, a bottom surface, a top surface, and a plurality of open-faced storage compartments disposed between the ring surface and the outer ring surface. The open-faced storage compartments each have an opening at the top surface, and a printed designation associated with each given storage compartment of the plurality of storage compartments, and are covered or closed by the cover when not in use, and exposed when in use by the user so that a user may access pills contained therein through a dispensing opening in the cover when a user rotates or dials a specific compartment. When in use, the user will be accessing typically one designated compartment according to a printed designation associated therewith (such as a given day of the week labeled for a given compartment), and may be accessing the given individual compartment for at least one pill (as used herein, the term “pill” may collectively refer to pills, tablets, capsules, vitamins, etc.) at an appropriate time for taking the pill. A reminder means is provided on the dial pill dispenser so as to be visible by a user. In one embodiment, the reminder means comprises a clock and alarm, although other notification approaches may be utilized, such as flashing LEDs or vibration alarms for the hearing impaired, or other alarm variants, whether visual, audio, or other means as known in the art of alarms.

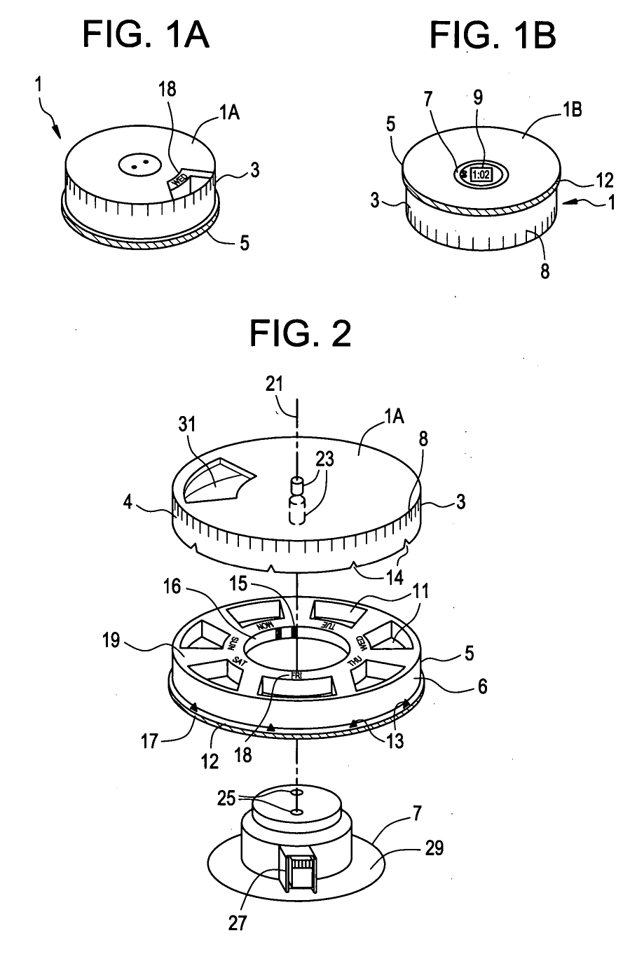

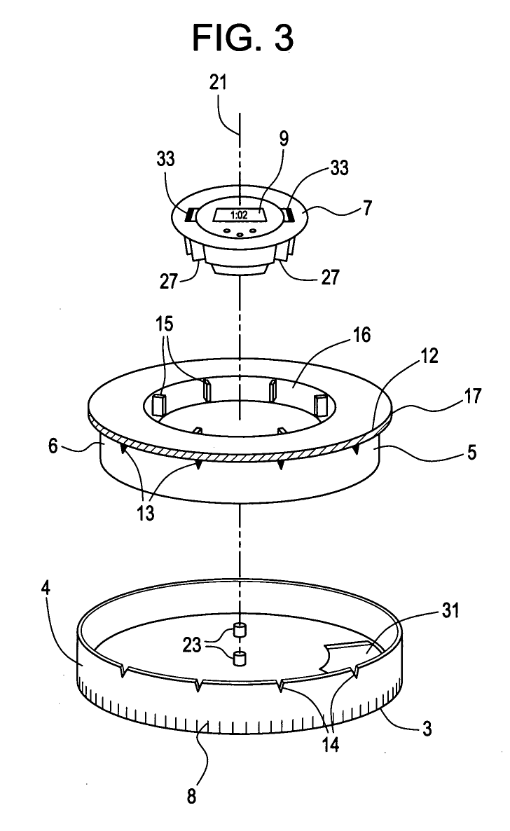

With ongoing reference to FIGS. 1A, 1B, 2, and 3, the invention specifically comprises the following. Cover 3 comprises a top surface 1A with a dispensing aperture 31, connector interface prongs 23, dependant skirt 4, and a continuous array of recesses 14 along the periphery of its dependant skirt 4. Dependant skirt 4 has a circumferentially situated grip surface 8 that may be grooved, serrated, fitted with rubberized grip material, or molded with exaggerated undulations for the benefit of users whose hands may be physically impaired because of arthritis or other physical impairment. The relatively large diameter and shallow depth of the dial type pill dispenser enable it to be easily grasped moreover, its large radius provides high torque to an elderly or infirm person who is attempting to rotate cover 3 and tray 5, and when combined with the above referenced easy-to-grip surfaces 8, 12, furnishes a high degree of manipulative capability. In addition to its torque characteristics, the dial pill dispenser is shallow and wide in order to provide storage space for an entire week and instant accessibility to any selected compartment 11. In one exemplary embodiment, a preferred diameter of the dial-type pill dispenser 1 is suitably six to ten times, and preferably eight times, its desired depth.

Cover 3 has a connector hub 7 for being fixed rotably within the center opening of the toroidal tray 5. Connector hub 7 is preferably made of resilient construction so that it is adapted to receive and hold reminder means 9 (via pichable clips 33 therein) and so as to lock together with cover 3 at the connector interface prongs 23 as fitted into interface prong recesses 25, and within toroidal tray 5 between cam receptors 27 and cams 15, while serving as a central hub around which the cover 3 and tray 5 can be cooperatively rotated relative to each other as desired. Hence, cover 3 is rotably fixed around said central axis 21 of the toroidal tray 5 so that its dispensing opening or aperture 31 will uncover a designated storage compartment 11 vwhen the user dials the dispenser 1 as described herein. Connector hub 7 is axially aligned with the central axis 21 of tray 5, and extends proximately from the bottom surface 1B of tray 5, along the central axis 21, until the proximate top surface 1A of tray 5. Connector hub 7 therefore terminates at hub interface 23 of cover 3 in such a way so as to rotably fix cover 3 and so as to secure tray 5 and so as to be capable of relative rotation with respect to each other.

Situated on/or within connector hub 7 at the bottom surface 1B is the reminder means 9 and as one skilled in the art may appreciate however, the exact construction of the reminder means itself may be of any one, or combination of clock and alarm modules commercially available today. Whichever means of alarm is selected, the reminder means may be preset or set by the user to go off when the attached clock (preferably a simple LCD clock) reaches the pre-selected or designated time and/or date.

Tray 5 has a bottom surface 1B and an inner ring surface 16 with at least two cams 15 set thereon for cam fitting for cam receptors 27 of connector hub 7, a plurality of open-faced storage compartments 11 with attendant printed markings 18, an anti-compartment 19, outer surface 6 set back concentrically from the outer periphery 17. Outer periphery has 17 has a grip surface 12 that may also be modified in accordance with grip surface 8 as described above. Further provided on outer periphery 17 are notches 13.

The notches 13 and recesses 14 together form a measured, cooperating rotational control and stop means that provide access to a given days selected dosage. Hence, if the user's sight is impaired, he can hear and feel the notch 13 and recess 17 engage each other, corresponding to successive days of the week (or the next designated dose as marked at 18), as he twirls the tray and cover until the next notch encountered which will lne up aperture 31 with a compartment 11, or anti-compartment 19. In this way, it is not altogether necessary to identify the days of the week, provided that tray and cover are only turned one notch at a time at the end of each day or administration.

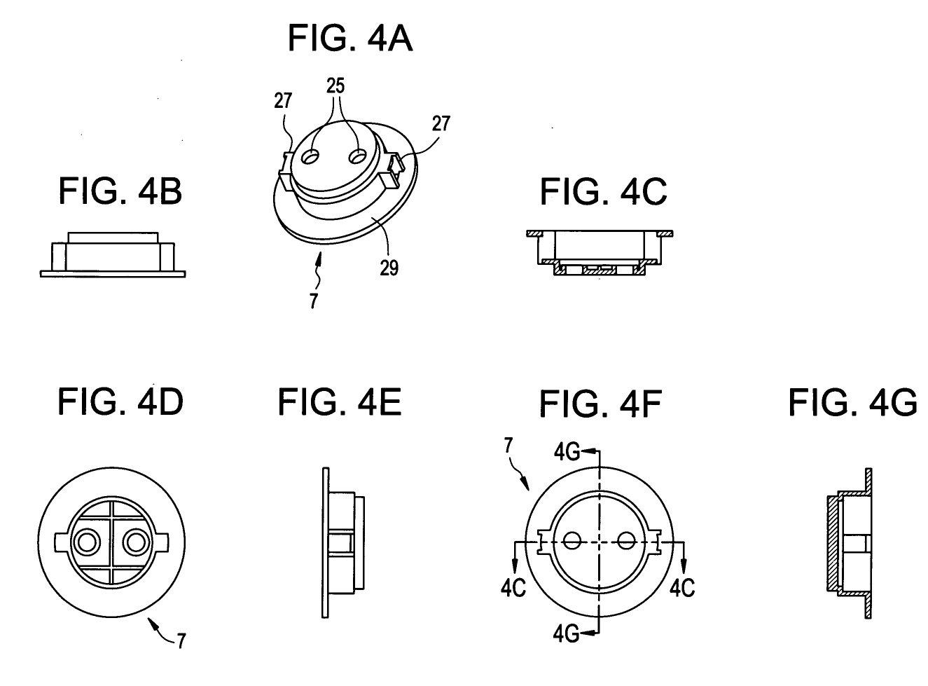

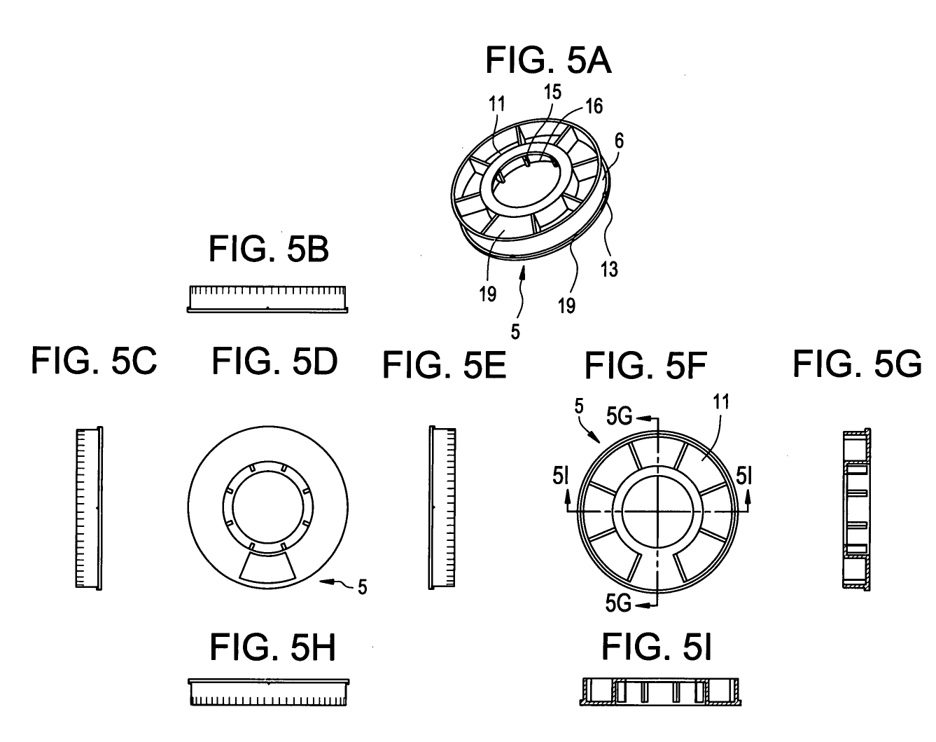

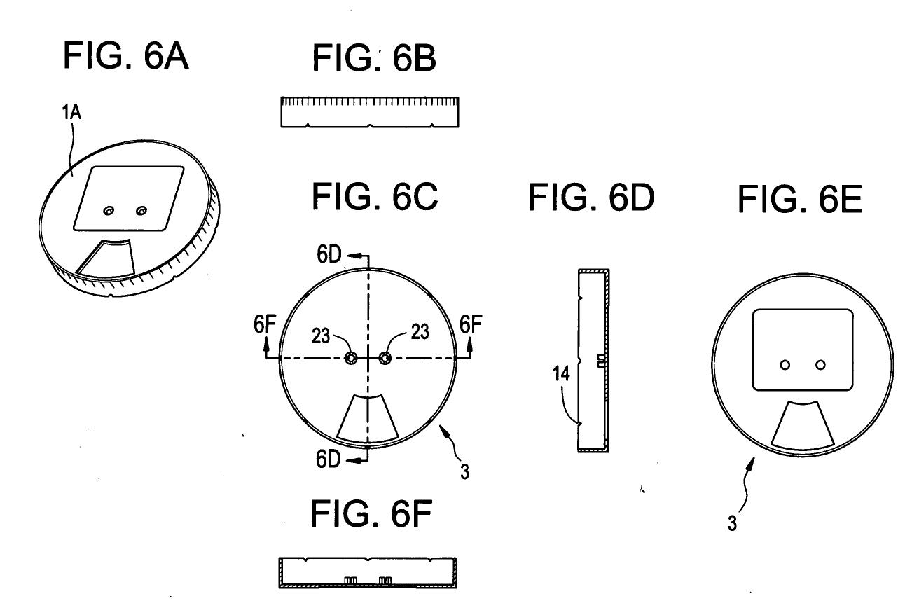

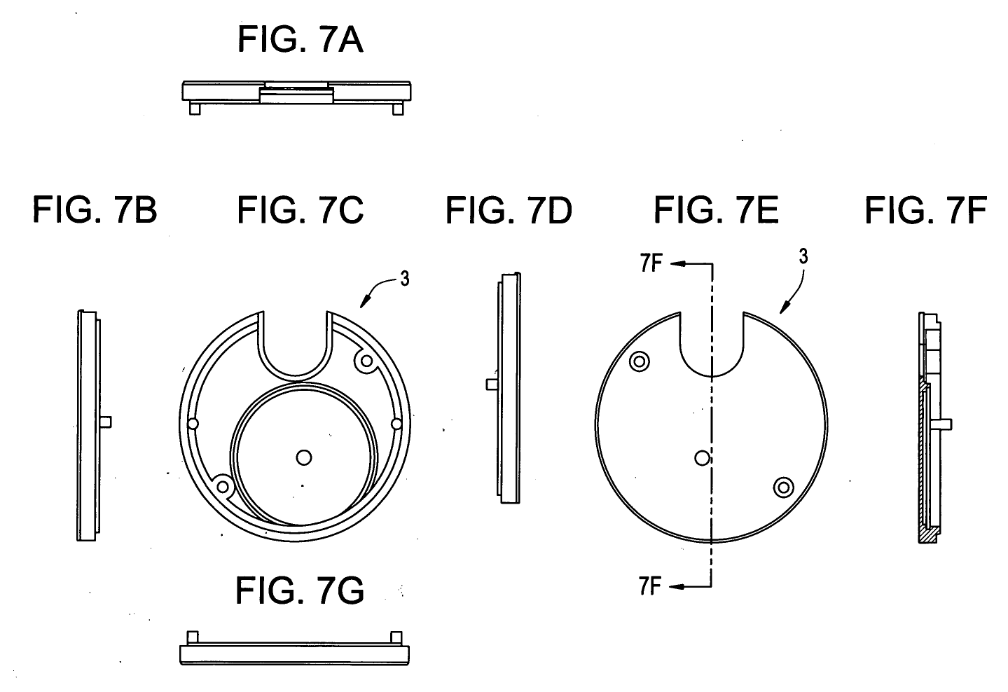

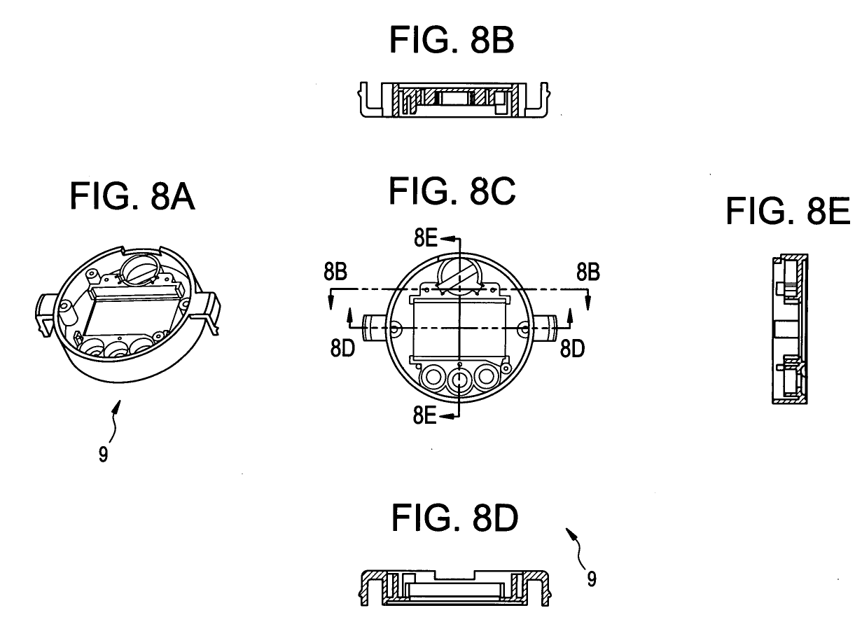

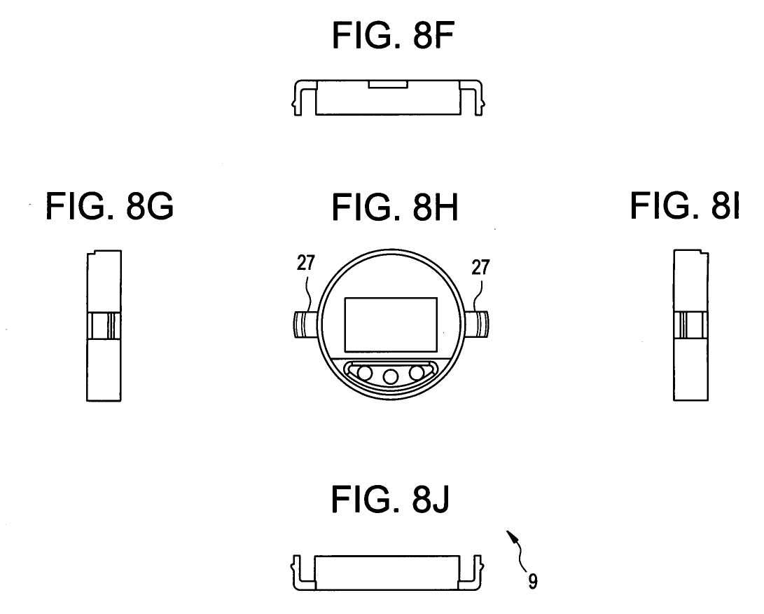

In accordance with the above structure, all components of the dispenser are preferably manufactured by molding from a transparent or opaque synthetic plastic material, such as polymethyl methacrylate, polystyrene, polybutylacrylate, and nylon, or mixtures thereof, having substantial rigidity but sufficient flexibility for snap fitting and camming movements. In this regard, FIGS. 4-9 may be generally referenced for an exemplary illustration of specifically how each of the above described individual portions of the invention may be formed and manufactured in or more embodiments.

When structured as such, the user may utilize the invention as follows. By way of one example, aperture 31 of dial-type pill dispenser 1 is closed by leaving anti-compartment 19 exposed, while further rotation thereafter opens up the next storage compartment 11 through aperture 31 at the time needed. At the next time for removing pills, cover 3 may be rotated from tray 5 again until the next, appropriately marked storage compartment 11 is reached.

In the case of a user who is visually impaired, he can utilize dial-type pill dispenser 1 by locating the desired day, as indicated by an optionally provided marking 18 having large text, bright colors, or Braille symbols. Once identified, he can rotate cover 3 until marking 18 is either seen or felt by the fingertip and then can invert the dial-type pill dispenser 1 over a cupped hand or other receptacle to obtain the stored dosage. Of course, for a person on regular medication, it is not absolutely necessary to commence the weeks sequence on the correct day. As soon as a daily dosage is retrieved, the next day (where a weekly regimen has been chosen for the particular embodiment) necessarily follows by rotating the lids 1/7 turn.

This application—taken as a whole with the specification, claims, abstract, and drawings—provides sufficient information for a person having ordinary skill in the art to practice the invention disclosed and claimed herein. Any measures necessary to practice this invention are well within the skill of a person having ordinary skill in this art after that person has made a careful study of this disclosure. Modification of this method and apparatus can become clear to a person having ordinary skill in this particular art; all such modifications are clearly covered by this disclosure.

What is claimed is:

1. A dial-type pill dispenser with reminder means comprising:
a toroidal tray formed about a plane, said tray having a central axis substantially perpendicular to said plane, and further having an inner ring surface, an outer ring surface, a bottom surface, a top surface, and a plurality of open-faced storage compartments disposed between said ring surface and said outer ring surface, wherein said open-faced storage compartments each have an opening at said top surface, and a printed designation associated with each given storage compartment of said plurality of storage compartments;
a dispensing cover having a hub interface and a dispensing aperture, said cover being rotably fixed around said central axis of said toroidal tray in such a way as to cover said openings at said top surface of said plurality of open faced storage compartments when individually not in use, and so as to expose one of said plurality of open-faced storage compartments when in use;
a connector hub, having an axis substantially aligned with said central axis of said tray, said hub extending proximately from said bottom surface of said tray along said central axis through said toroidal tray proximate to said top surface said tray, terminating at said hub interface of said dispensing cover in such a way so as to rotably fix said cover and cam fitting at said inner ring surface of said tray so as to secure said toroidal tray and said dispensation cover together so as to be capable of relative rotation with respect to each other; and
a reminder means provided on said dial pill dispenser so as to be visible by a user, said reminder comprising a clock and alarm.

2. The dispenser of claim 1, wherein said toroidal tray has an easy-to-grip surface circumferentially situated thereon, for rotating said toroidal tray, said wherein dispensing cover has an easy-to-grip surface circumferentially situated thereon for rotating said dispensing cover.

3. The dispenser of claim 2, wherein there are a plurality of compartments and wherein said printed markings reflects at least each of the seven days of the week associated respectively with at least seven of said plurality of compartments.

4. The dispenser of claim 3, wherein said toroidal tray further includes notches, and wherein said dispensation tray includes matching recesses, said recesses and said notches being adapted to cooperatively fit with each other so as to provide measured resistance to rotation of said toroidal tray and said dispensing cover with respect to each other.

5. The dispenser of claim 4, wherein said reminders means is fixed to said connector hub and wherein said alarm of said reminder means includes both and audible and visual indicator means.

6. The dispenser of claim 5, wherein said easy-to-grip surfaces have enlarged grip patterns for aiding usage by physically impaired users.

7. The dispenser of claim 6, wherein said printed markings of each said plurality of compartments is printed in such a way so as to be readable by visually impaired users.
